(19) United States
(12) Patent Application Publication
(10) Pub. No.: US 2005/0270399 A1
(43) Pub. Date: Dec. 8, 2005

(54) Image pickup apparatus, method of controlling the apparatus, and program for implementing the method, and storage medium storing the program

(75) Inventors: Zenya Kawaguchi, Setagaya-ku (JP); Masato Kosugi, Yokohama-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/145,028

(22) Filed: Jun. 3, 2005

(30) Foreign Application Priority Data
Jun. 3, 2004 (JP) 2004-166341

(51) Int. Cl. H04N 5/222

(52) U.S. Cl. 348/333.11

(57) ABSTRACT

An image pickup apparatus which increases the rate at which a person's face is detected in electronic zoom and accurately focuses on a person's face area and provides exposure/white balance control. An A/D converting unit converts an analog signal obtained from an image pickup device into a digital image signal. A signal processing unit performs signal processing on the digital image signal as image data. A display unit displays a zoom area in the image data magnified/reduced to a desired angle of view. A face detecting unit detects a person's face area from image data of a face detecting area narrower than the whole area of the image data and wider than the zoom area to acquire information on the person's face area.

### CROSS REFERENCE TO RELATED APPLICATION

This application claims priority from Japanese Patent Application No. 2004-166341 filed Jun. 3, 2004, which is hereby incorporated by reference herein.

### BACKGROUND OF THE INVENTION

1. Field of the Invention

The present invention relates to an image pickup apparatus such as a digital still camera, a method of controlling the apparatus, a program for implementing the method, and a storage medium storing the program.

2. Description of the Related Art

An image pickup apparatus such as a digital still camera has been required to be capable of shooting a person's face as a main subject by the optimum exposure when focusing on the person's face.

A conventional AF/AE (Auto Focus/Auto Exposure) controller provides control such that an area defined in advance within an image pickup screen is set as a ranging/photometry area, and focusing and exposure are performed in accordance with the ranging/photometry area. Therefore, in the case where a person's face as a main subject is not included in the ranging/photometry area, focusing and exposure cannot be performed in accordance with the person's face.

For example, assuming that the central part of the screen is set as the ranging/photometry area, if shooting is performed with a composition in which two persons are lined up as shown in FIG. 8A or a composition in which a person is shifted from the central part to the right in the screen as shown in FIG. 8B, focusing and exposure are performed in accordance with the background. It should be noted that in FIGS. 8A and 8B, the ranging/photometry area is indicated as a gray area.

On the other hand, in Japanese Laid-Open Patent Publication (Kokai) No. 2003-107555, for example, there is proposed an image pickup apparatus which detects a person's face area from an image within a screen (shot image) and extracts AF/AE evaluation values from the detected area to perform focusing and exposure using the extracted AF/AE evaluation values.

Similarly, in carrying out electronic zoom in which part of a screen is electronically zoomed to perform shooting, a face area detecting section has to detect a person's face area within the electronically zoomed area of the screen, and a controller has to perform focusing and exposure in accordance with the detected person's face. There are two methods of setting an area where the person's face is detected (face detecting area). In the first method, the entire screen is set as the face detecting area, and the controller performs focusing and exposure in accordance with a part of the detected person's face which is included in an electronic zoom area. In the second method, the face detecting area is set exactly to the electronic zoom area.

For example, as shown in FIGS. 9A and 9B, if the electronic zoom area is indicated as an area enclosed by the dotted line and the face detecting area is indicated as a gray area, the relationship between the electronic zoom area and the face detecting area is as shown in FIG. 9A according to the first method and as shown in FIG. 9B according to the second method.

According to Japanese Laid-Open Patent Publication (Kokai) No. H06-217187, a person's face is detected by the first method. Specifically, a face detecting section detects a person's face from image data over the entire screen, and a controller controls the magnifications of optical zoom and electronic zoom so as to make the size of the person's face constant.

In the first method, however, as the magnification in electronic zoom is increased so as to make the size of a person's face constant, the ratio of the person's face in the entire screen is decreased. For example, where an image with a composition as shown in FIG. 10A is shot using an electronic zoom function, the ratio of the person's face in the entire screen becomes smaller as shown in FIG. 10B. In FIG. 10B, an area enclosed by the dotted line is the electronic zoom area.

Here, there is the problem that as the ratio of a person's face in the face detecting area is decreased, the efficiency of detection of the person's face lowers.

Specifically, to detect the position of a person's face area, there have been proposed e.g. a method in which the position of a person's face is determined based on the shape of a skin-color region of a shot image as disclosed in Japanese Laid-Open Patent Publication (Kokai) No. H05-041830, and a method in which the position of a person's face is detected by performing pattern matching between a shot image and a plurality of discrimination patterns as disclosed in Japanese Laid-Open Patent Publication (Kokai) No. H09-251534. In the former method, however, the area of the skin-color region. is used as a criterion for the determination, and hence it is impossible to detect a person's face if it is too small. Also, in the latter method, to detect small person's faces, it is necessary to store additional discrimination patterns therefor, which increases the period of time required for processing and makes it actually impossible to detect a person's face unless it is larger than a predetermined size.

Accordingly, in the case where a person's face is small, it is envisaged that the above-mentioned second method in which the face is detected from an area subjected to electronic zoom is used. In the second method, however, if part of a person's face extends beyond the electronic zoom area as in the case where a person's face is shot in close-up using an electronic zoom function with such a composition as shown in FIG. 11A, or in the case where shooting is performed using an electronic zoom function with a composition in which a person moves to an edge of the electronic zoom area as shown in FIG. 11B, there is the problem that the person's face inside the electronic zoom area does not correspond to any discrimination pattern although the camera actually holds image pickup data on an area outside the electronic zoom area, and therefore the person's face cannot be detected as a person's face, and thus the rate of detection of a person's face is lowered.

### SUMMARY OF THE INVENTION

It is an object of the present invention to provide an image pickup apparatus and a method of controlling the image pickup apparatus, which are capable of increasing the rate of detection of a main subject such as a person's face in carrying out electronic zoom to thereby accurately perform focusing on a main subject area and exposure/white balance control, a program for implementing the method, and a storage medium storing the program.

To attain the above object, in a first aspect of the present invention, there is provided an image pickup apparatus comprising an image pickup device, an A/D converting unit that converts an analog signal obtained from the image pickup device into a digital image signal, a signal processing unit that performs signal processing on the digital image signal as image data, a display unit that displays a zoom area in the image data magnified/reduced to a desired angle of view, and a main subject detecting unit that detects a main subject area from image data of a main subject detecting area narrower than a whole area of the image data and wider than the zoom area to acquire information on the main subject area.

With the arrangement of the first aspect of the present invention, an area where a main subject such as a person's face is detected in carrying out electronic zoom is set to be narrower than the entire screen and wider than the electronic zoom area. As a result, it is possible to increase the rate of detection of the main subject to thereby accurately perform focusing on a main subject area and exposure/white balance control.

Preferably, the image pickup apparatus further comprises a control unit that controls at least one of ranging, photometry, and white balance according to the information acquired by the main subject detecting unit.

Preferably, the image pickup apparatus further comprises a first magnifying/reducing unit that magnifies/reduces the zoom area in the image data to a desired angle of view, and a second magnifying/reducing unit that magnifies/reduces the main subject detecting area in the image data to a desired angle of view.

Preferably, the image pickup apparatus further comprises a magnifying/reducing unit that magnifies/reduces the zoom area and the main subject detecting area in the image data to a desired angle of view.

Preferably, the information on the main subject area is indicative of coordinates of the main subject area.

Preferably, the image pickup apparatus further comprises a recording unit that records image data of the zoom area.

To attain the above object, in a second aspect of the present invention, there is provided a method of controlling an image pickup apparatus including an image pickup device and a display device, comprising an A/D converting step of converting an analog signal obtained from the image pickup device into a digital image signal, a signal processing step of performing signal processing on the digital image signal as image data, a display step of displaying a zoom area in the image data magnified/reduced to a desired angle of view on the display device, and a main subject detecting step of detecting a main subject area from image data of a main subject detecting area narrower than a whole area of the image data and wider than the zoom area to acquire information on the main subject area.

According to this arrangement, the same effects can be provided as in the first aspect of the present invention.

Preferably, the method of controlling the image pickup apparatus further comprises a control step of controlling at least one of ranging, photometry, and white balance according to the information acquired in the main subject detecting step.

To attain the above object, in a third aspect of the present invention, there is provided a control program executed by an image pickup apparatus including an image pickup device and a display device, comprising an A/D converting module for converting an analog signal obtained from the image pickup device into a digital image signal, a signal processing module for performing signal processing on the digital image signal as image data, a display module for displaying a zoom area in the image data magnified/reduced to a desired angle of view on the display device, and a main subject detecting module for detecting a main subject area from image data of a main subject detecting area narrower than a whole area of the image data and wider than the zoom area to acquire information on the main subject area.

According to this arrangement, the same effects can be provided as in the first aspect of the present invention.

To attain the above object, in a fourth aspect of the present invention, there is provided a storage medium storing a control program executed by an image pickup apparatus including an image pickup device and a display device such that the control program is readable by the image pickup apparatus, the control program comprising an A/D converting module for converting an analog signal obtained from the image pickup device into a digital image signal, a signal processing module for performing signal processing on the digital image signal as image data, a display module for displaying a zoom area in the image data magnified/reduced to a desired angle of view on the display device, and a main subject detecting module for detecting a main subject area from image data of a main subject detecting area narrower than a whole area of the image data and wider than the zoom area to acquire information on the main subject area.

According to this arrangement, the same effects can be provided as in the first aspect of the present invention.

The above and other objects, features and advantages of the present invention will apparent from the following detailed description taken in conjunction with the accompanying drawings, in which like reference characters designate the same or similar component elements or parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the functional arrangement of an image pickup apparatus 100 according to a first embodiment of the present invention;

FIG. 2 is a flow chart showing a process carried out by the image pickup apparatus 100 of FIG. 1;

FIG. 3A is a view showing an example of a screen displayed when an electronic zoom function is used;

FIG. 3B is a view showing the relationship between the entire screen, zoom area, and person's face detecting area when the electronic zoom function is used;

FIG. 4 is a block diagram showing the functional arrangement of an image pickup apparatus 101 according to a second embodiment of the present invention;

FIG. 5 is a flow chart showing a process carried out by the image pickup apparatus 101 of FIG. 4;

FIG. 6 is a block diagram showing the functional arrangement of an image pickup apparatus 102 according to a third embodiment of the present invention;

FIG. 7 is a flow chart showing a process carried out by the image pickup apparatus 102 of FIG. 6;

FIG. 8A is a view showing an example of a composition in which two persons are lined up;

FIG. 8B is a view showing an example of a composition in which a person is shifted from a central part to the right in a screen;

FIG. 9A is a view showing a case where the entire screen is set as a face detecting area;

FIG. 9B is a view showing a case where a face detecting area is set exactly to an electronic zoom area;

FIG. 10A is a view showing an example of a screen displayed when the electronic zoom function is used;

FIG. 10B is a view showing the relationship between the entire screen, zoom area, and person's face detecting area when the electronic zoom function is used;

FIG. 11A is a view showing a composition in which a person's face extends beyond a zoom area; and

FIG. 11B is a view showing a composition in which a person's face extends beyond an edge of a zoom area.

### DETAILED DESCRIPTION OF THE PREFERRED EMBODIMENTS

Preferred embodiments of the present invention will be described in detail in accordance with the accompanying drawings.

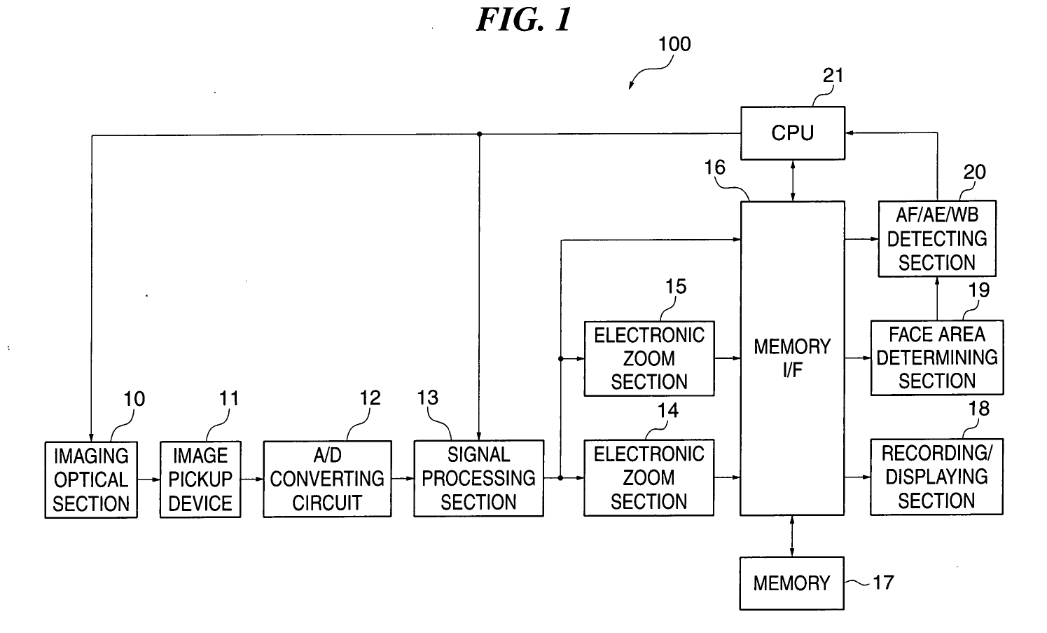

A detailed description will now be given of a first embodiment of the present invention with reference to FIGS. 1 to 3.

FIG. 1 is a block diagram showing the functional arrangement of an image pickup apparatus 100 according to the first embodiment.

In FIG. 1, reference numeral 10 denotes an imaging optical section comprised of a lens, a diaphragm, and so forth, for carrying out focus adjustment and exposure control. Reference numeral 11 denotes an image pickup device such as a CCD which converts.an optical image into an electric signal, and reference numeral 12 denotes an A/D converting circuit which converts an analog image signal output from the image pickup device 11 into digital image data. Reference numeral 13 denotes a signal processing section which creates image data by performing gamma processing, interpolation processing, matrix transformation, and so forth on data output from the A/D converting circuit 12. Each of reference numerals 14 and 15 denotes an electronic zoom section which electronically magnifies/reduces the size of image data in a designated range of a screen to a desired size (angle of view).

Reference numeral 16 denotes a memory I/F which provides interface for writing and reading image data and various control data to and from a memory (DRAM) 17, and reference numeral 18 denotes a recording/displaying section which compresses image data and stores the same in a recording medium such as a CF (Compact Flash) card. Reference numeral 19 denotes a face area determining section which determines the area of a person's face in image data. Reference numeral 20 denotes an AF/AE/WB detecting section which detects AF/AE/WB (Auto Focus/Auto Exposure/White Balance) evaluation values. Reference numeral 21 denotes a CPU which provides various kinds of control; i.e. the CPU 21 controls the imaging optical section 10 according to the AF/AE/WB evaluation values supplied from the AF/AE/WB detecting section 20 and sets parameters for signal processing to be performed by the signal processing section 13.

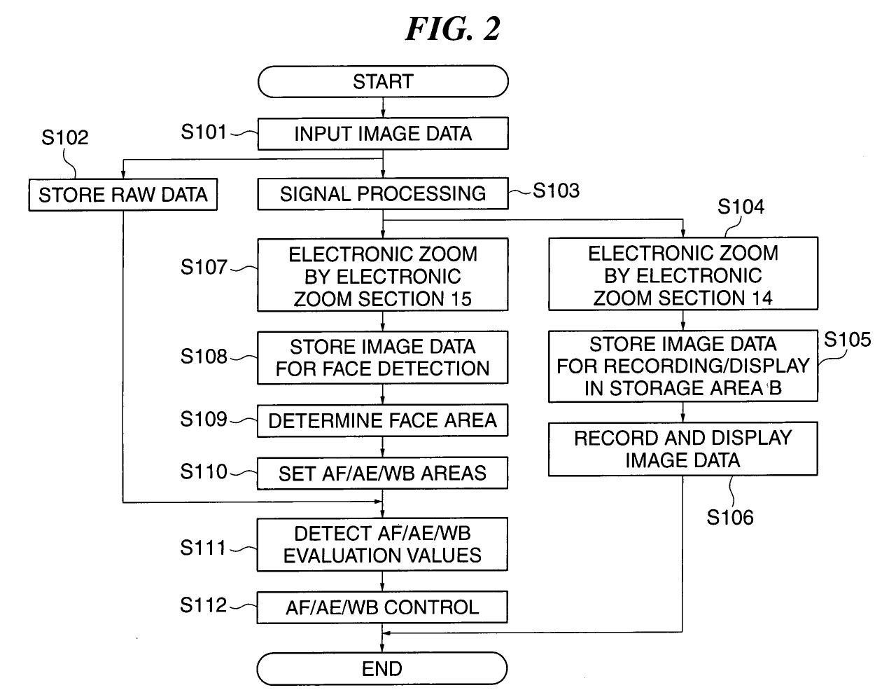

FIG. 2 is a flow chart showing a process carried out by the image pickup apparatus 100 in FIG. 1. In the following description, it is assumed that the image pickup apparatus 100 is permitted to use its electronic zoom function.

In a step S101, light incident on the imaging optical section 10 forms an image on a light receiving surface of the image pickup device 11 and output as an analog image signal by the image pickup device 11. Then, the analog image signal is converted into digital image data by the A/D converting circuit 12, and the converted digital image data is input to the signal processing section 13.

In the signal processing section 13, processing in a step S102 and processing in a step S103 are performed in parallel.

In the step S102, the signal processing section 13 stores the input image data as it is (as RAW-compressed data) in a predetermined storage area (storage area A) of the memory 17 via the memory I/F 16. On the other hand, in the step S103, the signal processing section 13 performs gamma processing, interpolation processing, matrix transformation, and so forth on the input image data to create image data for the entire screen and inputs the same to the electronic zoom sections 14 and 15.

The electronic zoom sections 14 and 15 are capable of individually setting an area where image data is to be cut out from the entire screen and the ratio of magnification/reduction. In the present embodiment, the position and size of a cutout area set by the electronic zoom section 14 are identical with those of an electronic zoom area, and the cutout area (face detecting area) set by the electronic zoom section 15. is set to be narrower than the entire screen and wider than the cutout area (electronic zoom area) set by the electronic zoom section 14. For example, if the image pickup apparatus 100 is provided with a ranging means, it is possible to estimate an approximate area size required for detecting a person's face by referring to information on a distance to the subject, information on the ratio of magnification/reduction in optical zoom, or information on the ratio of magnification/reduction in electronic zoom. It should be noted that the image pickup apparatus 100 may be provided with a setting section such as operating elements so that the user can make the above settings (i.e. settings as to the position and size of the electronic zoom area and the face detecting area and as to the ratios of magnification/reductions for these areas).

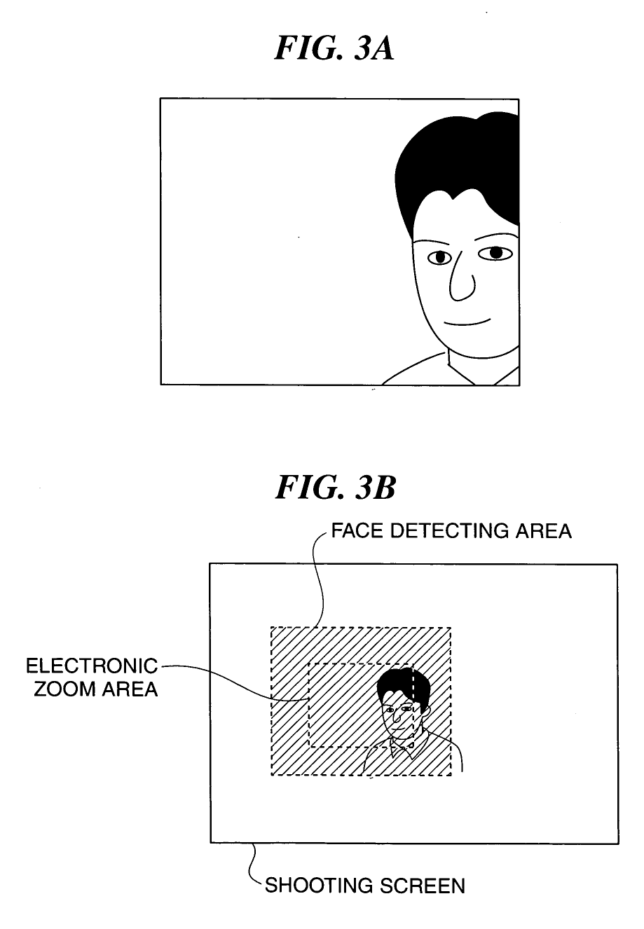

FIG. 3 shows the relationship between the electronic zoom area and the face detecting area. In FIG. 3, the electronic zoom area is an area enclosed by the dotted line, and the face detecting area is indicated as a gray area.

In a step S104, the electronic zoom section 14 electronically magnifies/reduces the size of image data for the electronic zoom area to create image data for recording/display.

In a step S105, the recording/displaying section 18 stores the recording/display image data created in the step S104 in a predetermined storage area (storage area B) of the memory 17 via the memory I/F 16.

In a step S106, the recording/displaying section 18 reads out the recording/display image data stored in the storage area B in the step S105 via the memory I/F 16 and compresses and records the readout image data in a recording medium such as a CF card. The recording/displaying section 18 also displays the readout image data on e.g. a LCD monitor, followed by terminating the process.

On the other hand, in a step S107, the electronic zoom section 15 electronically magnifies/reduces the size of image data for the face detecting area to create image data for face detection.

In a step S108, the electronic zoom section 15 stores the image data for face detection created in the step S107 in a predetermined storage area (storage area C) of the memory 17 via the memory I/F 16.

In a step S109, the face area determining section 19 detects a person's face area by using the image data for face detection, which was stored in the storage area C in the step S108. To detect a person's face area, there have been known a method using an eigenface by principal component analysis as disclosed in M. A. Turk and A. P. Pentland, “Face Recognition using Eigenfaces”, Proc. of IEEE Conf. on Computer Vision and Pattern Recognition, pp. 586-591, 1991, and a method using characteristic points such as eyes, nose, and mouse as disclosed in Japanese Laid-Open Patent Publication (Kokai) No. H09-251534. These methods can be applied to the present embodiment. In these methods, whether or not an input image represents a person's face is determined by performing pattern matching between the input image and a plurality of standard patterns. In the present embodiment, in the step S109, pattern matching is performed between standard patterns of person's face stored in advance in a storage area D of the memory 17 and the image data for face detection stored in the storage area C in the step S108. Coordinates are calculated from the person's face area thus detected and are set as information on the person's face area.

In a step S110, the AF/AE/WB detecting section 20 sets an area for detecting an AF evaluation value (AF area), an area for detecting an AE evaluation value, and an area for detecting a WB evaluation value (WB area) according to the information on the person's face area, which was detected in the step S109. If it is determined in the step S109 that there is no person's face (i.e. no person's area face can be detected), the AF/AE/WB detecting section 20 sets the AF/AE/WB areas by the usual method. It should be noted that the AF/AE/WB areas may be set by the CPU 21.

In a step S111, RAW-compressed data included in the AF/AE/WB areas set in the step S110 among RAW-compressed data stored in the storage area A in the step S102 is read into the AF/AE/WB detecting section 20 to detect AF/AE/WB evaluation values.

In a step S112, the CPU 21 acquires AF/AE adjustment amounts based on the AF/AE evaluation values obtained in the step S111 and controls the imaging optical section 10 according to the acquired adjustment amounts. Further, the CPU 21 sets parameters for signal processing to be performed by the signal processing section 13 based on the AE/WB evaluation values obtained in the step S111.

As described above, according to the present embodiment, an area where a person's face is detected in carrying out electronic zoom is set to be narrower than the whole screen and wider than the electronic zoom area, whereby it is possible to increase the rate of detection of a person's face to thereby accurately focus on the person's face and provide accurate exposure/white balance control.

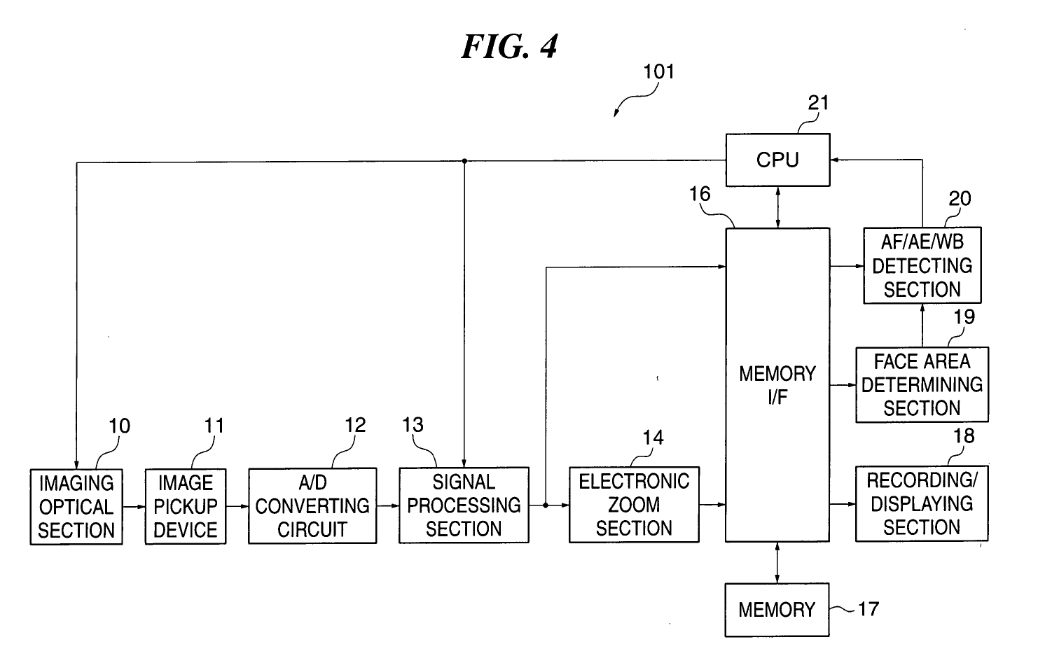

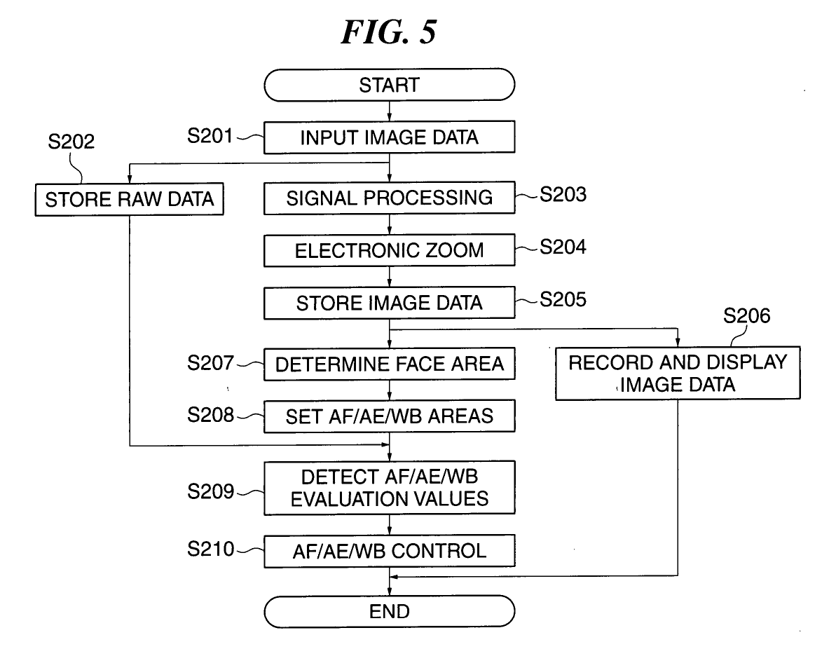

A detailed description will now be given of a second embodiment of the present invention with reference to FIGS. 4 and 5.

FIG. 4 is a block diagram showing the functional arrangement of an image pickup apparatus 101 according to the second embodiment.

While the image pickup apparatus 100 according to the first embodiment is provided with the two electronic zoom sections 14 and 15, the image pickup apparatus 101 according to the present embodiment is provided with only one electronic zoom section 14.

The construction of the image pickup apparatus 101 is the same as that of the image pickup apparatus 100 except for the construction of the electronic zoom section 14, and therefore description thereof is omitted.

FIG. 5 is a flow chart showing a process carried out by the image pickup apparatus 101 of FIG. 4. In the following description, it is assumed that the image pickup apparatus 101 is permitted to use its electronic zoom function.

In a step S201, light incident on the imaging optical section 10 forms an image on a light receiving surface of the image pickup device 11 and output as an analog image signal by the image pickup device 11. Then, the analog image signal is converted into digital image data by the A/D converting circuit 12, and the converted digital image data is input to the signal processing section 13.

In the signal processing section 13, processing in a step S202 and processing in a step S203 are performed in parallel.

In the step S202, the signal processing section 13 stores the input image data as it is (as RAW-compressed data) in a predetermined storage area (storage area A) of the memory 17 via the memory I/F 16. On the other hand, in the step S203, the signal processing section 13 performs gamma processing, interpolation processing, matrix transformation, and so forth on the input image data to create image data for the entire screen and inputs the same to the electronic zoom section 14.

In the present embodiment, the electronic zoom section 14 sets the ratio of magnification/reduction of the electronic zoom section 14 so that the electronic zoom area is equal in size to image data for recording/display, and sets an area where image data is cut out from the entire screen (face detecting area) to be narrower than the entire screen and wider than the electronic zoom area. It should be noted that the image pickup apparatus 101 may be provided with a setting section such as operating elements so that the user can make the above settings (i.e. settings as to the position and size of the electronic zoom area and the face detecting area as well as the ratios of magnification/reductions for these areas).

The relationship between the electronic zoom area and the face detecting area according to the present embodiment is the same as the relationship between the electronic zoom area and the face detecting area in FIG. 3 in the first embodiment. Therefore, image data created by the electronic zoom section 14 is larger than the image data for recording/display. In a step S206 described hereinafter, the recording/displaying section 18 cuts out a part of the image data created by the electronic zoom section 14 to record/display the same.

In a step S204, the electronic zoom section 14 electronically magnifies/reduces the size of image data for the face detecting area to create image data for recording/display.

In a step S205, the electronic zoom section 14 stores the recording/display image data created in the step S204 in a predetermined storage area (storage area B) of the memory 17 via the memory I/F 16. The face detecting area is set to be wider than the electronic zoom area so that the recording/display image data created in the step S204 includes the image data for recording/display.

In the step S206, the recording/displaying section 18 reads out the image data in the electronic zoom area among the image data for the face detecting area stored in the storage area B in the step S205 via the memory I/F 16 and compresses and records the readout image data in a recording medium such as a CF card. The recording/displaying section 18 also displays the readout image data on e.g. a LCD monitor, followed by terminating the process.

In a step S207, the face area determining section 19 detects a person's face area using the image data for the face detecting area stored in the storage area B in the step S205. It should be noted that the same method as the method used in the first. embodiment can be used to detect the person's face area.

In a step S208, the AF/AE/WB detecting section 20 sets an area for detecting an AF evaluation value (AF area), an area for detecting an AE evaluation value, and an area for detecting a WB evaluation value (WB area) according to the information on the person's face area, which was detected in the step S207. If it is determined in the step S207 that there is no person's face (i.e. no person's area face can be detected), the AF/AE/WB detecting section 20 sets the AF/AE/WB areas by the usual method. It should be noted that the AF/AE/WB areas may be set by the CPU 21.

In a step S209, RAW-compressed data included in the AF/AE/WB areas set in the step S208 among RAW-compressed data stored in the storage area A in the step S202 is read into the AF/AE/WB detecting section 20 to detect AF/AE/WB evaluation values.

In a step S210, the CPU 21 acquires AF/AE adjustment amounts based on the AF/AE evaluation values obtained in the step S209 and controls the imaging optical section 10 according to the acquired adjustment amounts. Further, the CPU 21 sets parameters for signal processing to be performed by the signal processing section 13 based on the AE/WB evaluation values obtained in the step S209.

As described above, according to the present embodiment, an area where a person's face is detected in carrying out electronic zoom is set to be narrower than the whole screen and wider than the electronic zoom area, whereby it is possible to increase the rate of detection of a person's face to thereby focus on the person's face and provide accurate exposure/white balance control. Also, the image pickup apparatus is provided with only one electronic zoom section, making the apparatus com pact and reducing manufacturing costs.

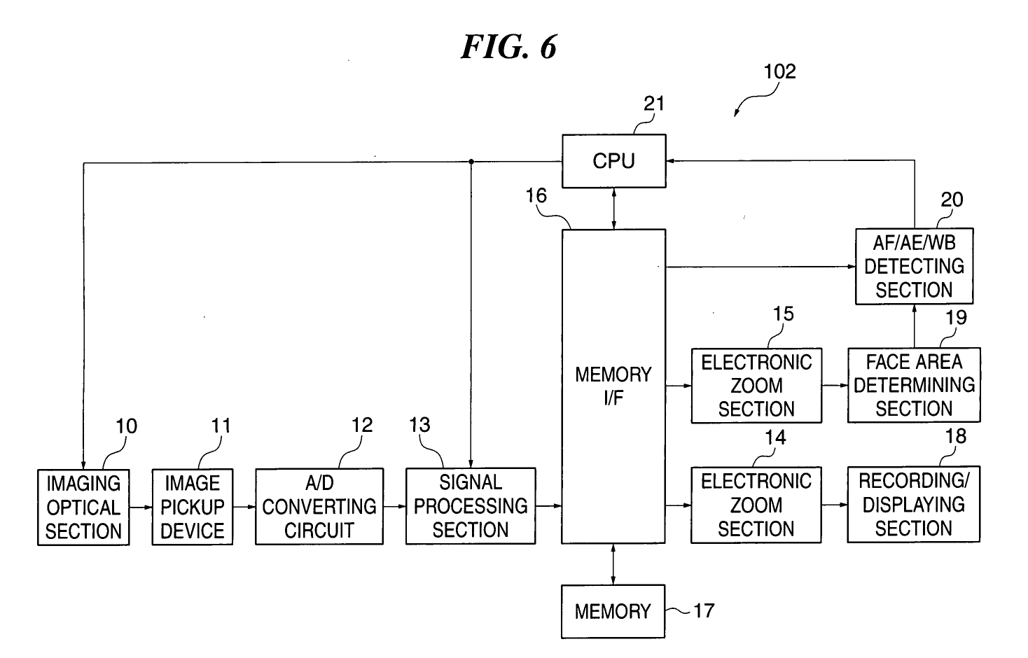

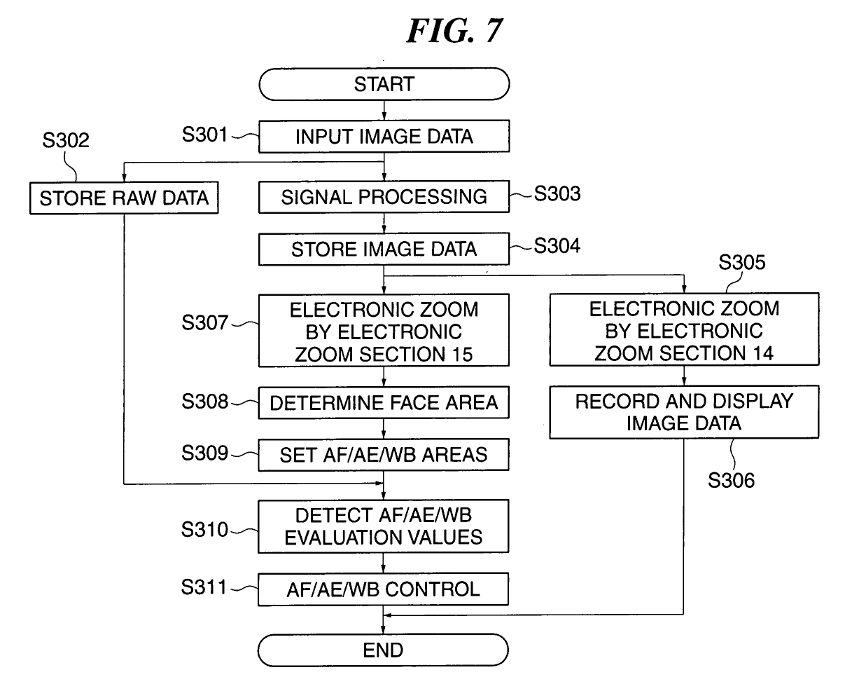

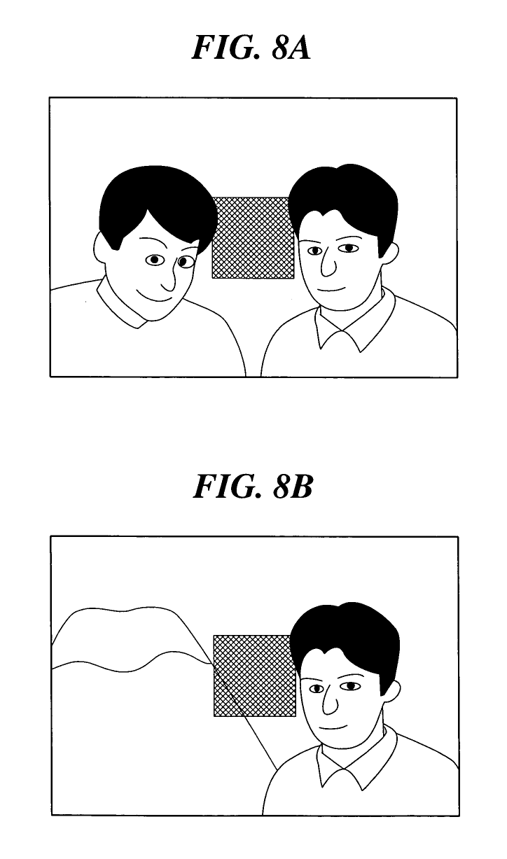

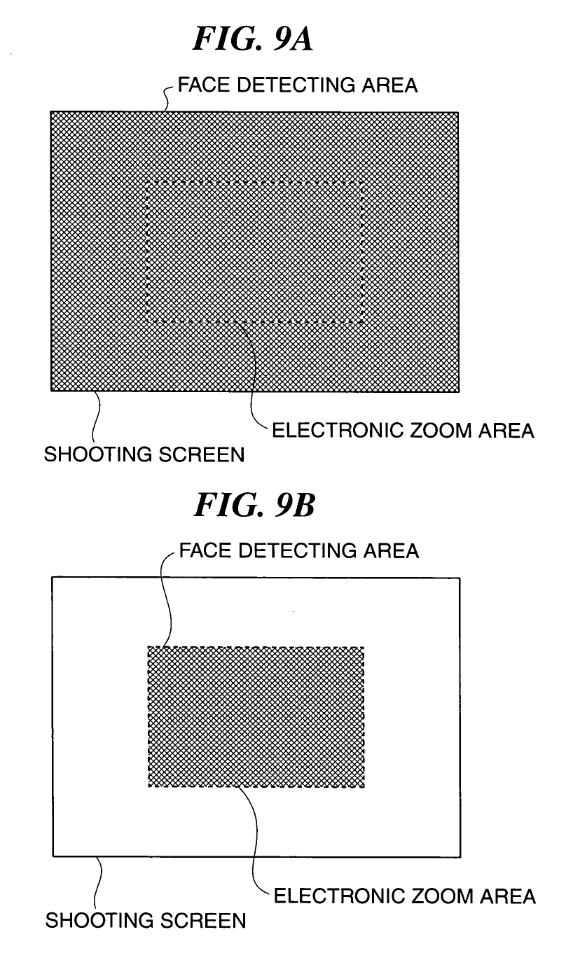

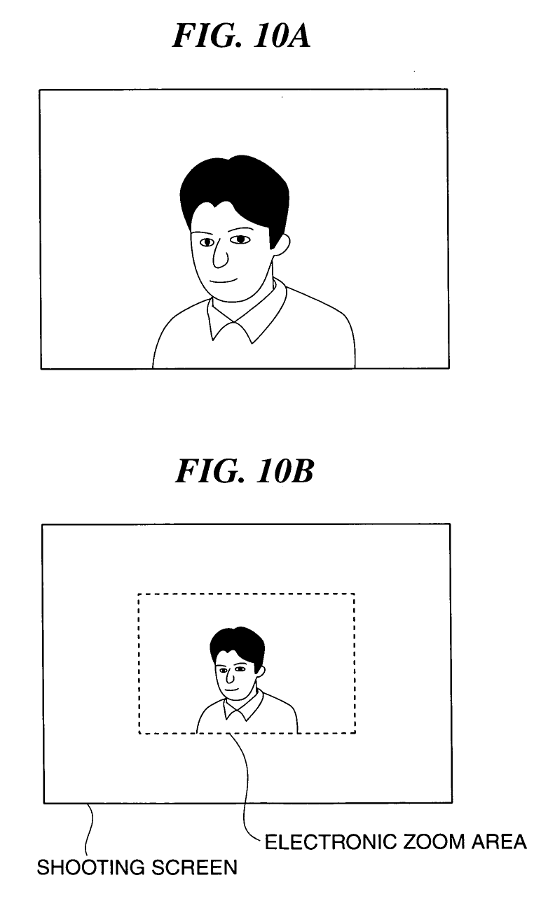

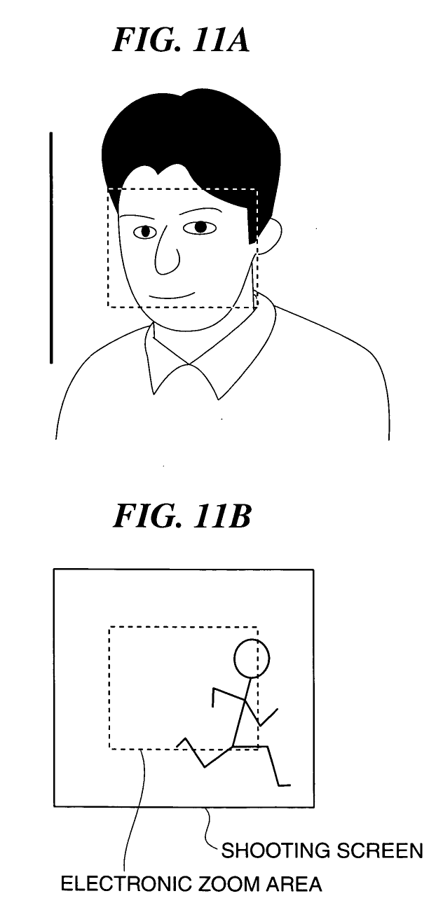

A detailed description will now be given of a third embodiment of the present invention with reference to FIGS. 6 and 7.

FIG. 6 is a block diagram showing the functional arrangement of an image pickup apparatus 102 according to the third embodiment.

The image pickup apparatus 102 is provided with all the component elements of the image pickup apparatus 100 according to the first embodiment. While in the image pickup apparatus 100, the electronic zoom sections 14 and 15 are provided between the signal processing section 13 and the memory I/F 16, in the image pickup apparatus 102, the electronic zoom section 14 is provided between the memory I/F 16 and the recording/displaying section 18, and the electronic zoom section 15 is provided between the memory I/F 16 and the face area determining section 19. Except for the above, the construction of the image pickup apparatus 102 is the same as that of the image pickup apparatus 100, and therefore description thereof is omitted.

FIG. 7 is a flow chart showing a process carried out by the image pickup apparatus 102 in FIG. 6. In the following description, it is assumed that an electronic zoom function of the image pickup apparatus 102 is on.

In a step S301, light incident on the imaging optical section 10 forms an image on a light receiving surface of the image pickup device 11 and output as an analog image signal by the image pickup device 11. Then, the analog image signal is converted into digital image data by the A/D converting circuit 12, and the converted digital image data is input to the signal processing section 13.

In the signal processing section 13, processing in a step S302 and processing in a step S303 are performed in parallel.

In the step S302, the signal processing section 13 stores the input image data as it is (as RAW-compressed data) in a predetermined storage area (storage area A) of the memory 17 via the memory I/F 16. On the other hand, in the step S303, the signal processing section 13 performs gamma processing, interpolation processing, matrix transformation, and so forth on the input image data to create image data for the entire screen.

In a step S304, the signal processing section 13 stores the image data for the entire screen created in the step S303 in a predetermined storage area (storage area B) of the memory 17 via the memory I/F 16.

In a step S305, the electronic zoom section 14 reads out image data for the electronic zoom area among the image data for the entire screen, which was stored in the storage area B in the step S304, via the memory I/F 16 and electronically magnifies/reduces the size of the readout image data to create image data for recording/display.

In a step S306, the recording/displaying section 18 compresses the image data for recording/display created in the step S305 and records the same in a recording medium such as a CF card. Also, the recording/displaying section 18 displays the readout image data on e.g. a LCD monitor, followed by terminating the process.

In a step S307, the electronic zoom section 15 sets an area, which is narrower than the entire screen and wider than the electronic zoom area, as a face detecting area, reads out image data of the face detecting area among the image data for the entire screen stored in the storage area B in the step S304 via the memory I/F 16, and electronically magnifies/reduces the size of the readout image data to create image data for face detection. It should be noted that the image pickup apparatus 102 may be provided with a setting section such as operating. elements so that the user can make the above settings (i.e. settings as to the position and size of the electronic zoom area and the face detecting area as well as the ratios of magnification/reductions for these areas). The relationship between the electronic zoom area and the face detecting area is the same as the relationship in FIG. 3 in the first embodiment.

In a step S308, the face area determining section 19 detects a person's face area by using the image data for face detection, which was stored in the storage area C in the step S307. The same method as the method used in the first embodiment can be used to detect the person's face area.

In a step S309, the AF/AE/WB detecting section 20 sets an area for detecting an AF evaluation value (AF area), an area for detecting an AE evaluation value, and an area for detecting a WB evaluation value (WB area) according to the information on the person's face area, which was detected in the step S308. If it is determined in the step S308 that there is no person's face (i.e. no person's area face can be detected), the AF/AE/WB detecting section 20 sets the AF/AE/WB areas by the usual method. It should be noted that the AF/AE/WB areas may be set by the CPU 21.

In a step S310, RAW-compressed data included in the AF/AE/WB areas set in the step S309 among RAW-compressed data stored in the storage area A in the step S302 is read into the AF/AE/WB detecting section 20 to detect AF/AE/WB evaluation values.

In a step S311, the CPU 21 acquires AF/AE adjustment amounts based on the AF/AE evaluation values obtained in the step S310 and controls the imaging optical section 10 according to the acquired adjustment amounts. Further, the CPU 21 sets parameters for signal processing to be performed by the signal processing section 13 based on the AE/WB evaluation values obtained in the step S310.

As described above, according to the present embodiment, an area where a person's face is detected in carrying out electronic zoom is set to be narrower than the whole screen and wider than the electronic zoom area, whereby it is possible to increase the rate of detection of a person's face to thereby accurately focus on the person's face and provide accurate exposure/white balance control.

The above described first to third embodiments of the present invention can be realized by any image pickup apparatus insofar as it is constructed as shown in any of FIGS. 1, 4, and 6. Examples of the image pickup apparatus include a digital still camera, a cellular phone with a digital camera (such as a PHS terminal), and a digital camera-equipped computer (such as a PDA).

It is to be understood that the object of the present invention may also be accomplished by supplying a system or an apparatus with a storage medium in which a program code of software, which realizes the functions of any of the above described embodiments is stored, and causing a computer (or CPU or MPU) of the system or apparatus to read out and execute the program code stored in the storage medium.

In this case, the program code itself read from the storage medium realizes the functions of any of the above described embodiments, and hence the program code and a storage medium on which the program code is stored constitute the present invention.

Further, it is to be understood that the functions of any of the above described embodiments may be accomplished not only by executing a program code read out by a computer, but also by causing an OS (operating system) or the like which operates on the computer to perform a part or all of the actual operations based on instructions of the program code.

Further, it is to be understood that the functions of any of the above described embodiments may be accomplished by writing a program code read out from the storage medium into a memory provided in an expansion board inserted into a computer or a memory provided in an expansion unit connected to the computer and then causing a CPU or the like provided in the expansion board or the expansion unit to perform a part or all of the actual operations based on instructions of the program code.

Further, the above program has only to realize the functions of any of the above-mentioned embodiments on a computer, and the form of the program may be an object code, a program executed by an interpreter, or script data supplied to an OS.

Examples of the storage medium for supplying the program code include a floppy (registered trademark) disk, a hard disk, a magnetic-optical disk, a CD-ROM, a CD-R, a CD-RW, a DVD (a DVD-ROM, a DVD-RAM, a DVD-RW, or a DVD+RW), a magnetic tape, a nonvolatile memory card, and a ROM. Alternatively, the program may be supplied by downloading from another computer, a database, or the like, not shown, connected to the Internet, a commercial network, a local area network, or the like.

1. An image pickup apparatus comprising:
an image pickup device;
an A/D converting unit that converts an analog signal obtained from said image pickup device into a digital image signal;
a signal processing unit that performs signal processing on the digital image signal as image data;
a display unit that displays a zoom area in the image data magnified/reduced to a desired angle of view; and
a main subject detecting unit that detects a main subject area from image data of a main subject detecting area narrower than a whole area of the image data and wider than the zoom area to acquire information on the main subject area.

2. An image pickup apparatus according to claim 1, further comprising a control unit that controls at least one of ranging, photometry, and white balance according to the information acquired by said main subject detecting unit.

3. An image pickup apparatus according to claim 1, further comprising a first magnifying/reducing unit that magnifies/reduces the zoom area in the image data to a desired angle of view, and a second magnifying/reducing unit that magnifies/reduces the main subject detecting area in the image data to a desired angle of view.

4. An image pickup apparatus according to claim 1, further comprising a magnifying/reducing unit that magnifies/reduces the zoom area and the main subject detecting area in the image data to a desired angle of view.

5. An image pickup apparatus according to claim 1, wherein the information on the main subject area is indicative of coordinates of the main subject area.

6. An image pickup apparatus according to claim 1, further comprising a recording unit that records image data of the zoom area.

7. A method of controlling an image pickup apparatus including an image pickup device and a display device, comprising:
an A/D converting step of converting an analog signal obtained from the image pickup device into a digital image signal;
a signal processing step of performing signal processing on the digital image signal as image data;
a display step of displaying a zoom area in the image data magnified/reduced to a desired angle of view on the display device; and
a main subject detecting step of detecting a main subject area from image data of a main subject detecting area narrower than a whole area of the image data and wider than the zoom area to acquire information on the main subject area.

8. A method of controlling the image pickup apparatus according to claim 7, further comprising a control step of controlling at least one of ranging, photometry, and white balance according to the information acquired in said main subject detecting step.

9. A control program executed by an image pickup apparatus including an image pickup device and a display device, comprising:
an A/D converting module for converting an analog signal obtained from the image pickup device into a digital image signal;
a signal processing module for performing signal processing on the digital image signal as image data;
a display module for displaying a zoom area in the image data magnified/reduced to a desired angle of view on the display device; and
a main subject detecting module for detecting a main subject area from image data of a main subject detecting area narrower than a whole area of the image data and wider than the zoom area to acquire information on the main subject area.

10. A storage medium storing a control program executed by an image pickup apparatus including an image pickup device and a display device such that the control program is readable by the image pickup apparatus, the control program comprising:
an A/D converting module for converting an analog signal obtained from the image pickup device into a digital image signal;
a signal processing module for performing signal processing on the digital image signal as image data;
a display module for displaying a zoom area in the image data magnified/reduced to a desired angle of view on the display device; and
a main subject detecting module for detecting a main subject area from image data of a main subject detecting area narrower than a whole area of the image data and wider than the zoom area to acquire information on the main subject area.
